(19) United States
(12) Patent Application Publication
(10) Pub. No.: US 2002/0092242 A1
(43) Pub. Date: Jul. 18, 2002

(54) Weather seal having elastomeric material encapsulating a bendable core

(76) Inventor: Robert B. Hope, Toronto (CA)

Correspondence Address: Kenneth J. LuKacher, Esq., South Winton Court, Suite 204, 3136 Winton Road, Rochester, NY, 14623, US

(21) Appl. No.: 10/033,518

(22) Filed: Dec. 28, 2001

Related U.S. Application Data
(60) Provisional application No. 60/258,930, filed on Dec. 29, 2000.

(51) Int. Cl. E06B 7/16

(52) U.S. Cl. 49/475.1; 49/489.1

(57) ABSTRACT

In order to reduce the cost of weather seal having a core or carrier which acts as an embedded support for the rubber-like (elastomeric) sealing material, the carrier is first contained within a substrate of low-cost rubber material, which may be applied to the core by extrusion of a substrate of recycled, reground (previously cured) rubber, preferably EPDM rubber which may include a thermoplastic olefinic material as a binder. This substrate is cohesive with an overlaying covering of uncured elastomeric material (EPDM rubber), which may be extruded over the substrate-encased carrier. The carrier, which may be sold separately or encased in the substrate, is provided to enable to the weather seal to be compressed or bent. Reinforcement elements are attached to the wire loops of the carrier, without knitting to the wire loops. The loops of the wire carrier are guided into and held in grooves in a wheel. Feed screws tangential to the wheel compress the loops. The compressed loops are brought to a process station where the reinforcement elements are applied and attached. The use of recycled cured material in a substrate and the replacement of yarn attached to a wire carrier by knitting, with overlaying reinforcement elements provides cost savings over conventional weather seal which is significant since such weather seal is used in large quantities in the automotive industry.

This application claims the benefit of priority to U.S. Provisional Patent Application No. 60/258,930, filed Dec. 29, 2000, which is herein incorporated by reference.

### DESCRIPTION

The present invention relates to weather stripping and particularly to weather seals having elastomeric material encapsulating a compressible, bendable core or carrier internal of the weather seal. The invention improves such weather seal by enabling the fabrication thereof with materials of lower cost than heretofore used and by the elimination of steps in the process of manufacture, all without materially affecting the suitability of such weather seals for their intended use. Such weather seals have been used to seal body parts such as windows, doors and trunks of automotive vehicles (cars and trucks) and are the subject of numerous patents relating to various styles and shapes of seals. A few of such patents are Mesnel, U.S. Pat. No. 4,310,164 of Jan. 12, 1982; Cook, U.S. Pat. No. 5,411,785 of May 2, 1995; Keys, U.S. Pat. No. 5,221,564 of Jun. 22, 1993; Landreth, U.S. Pat. No. 4,318,249 of Mar. 9, 1982 and Pullan, U.S. Pat. No. 4,232,081 of Nov. 4, 1980.

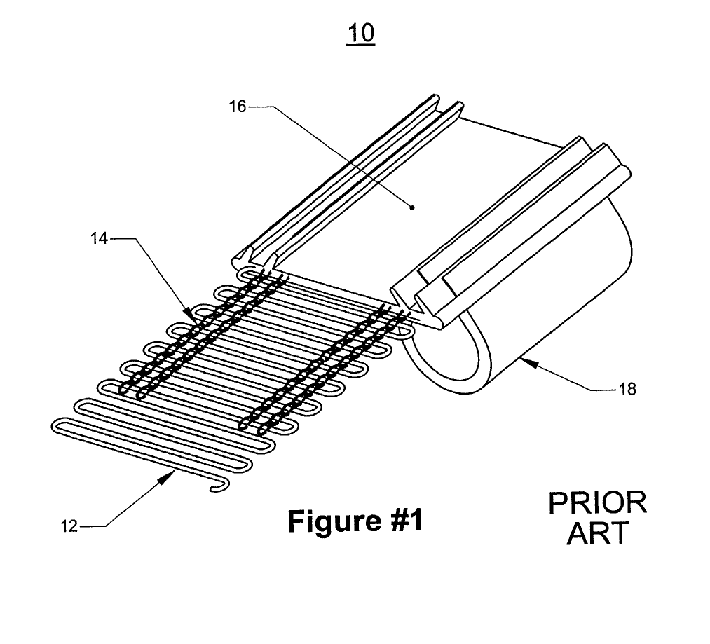

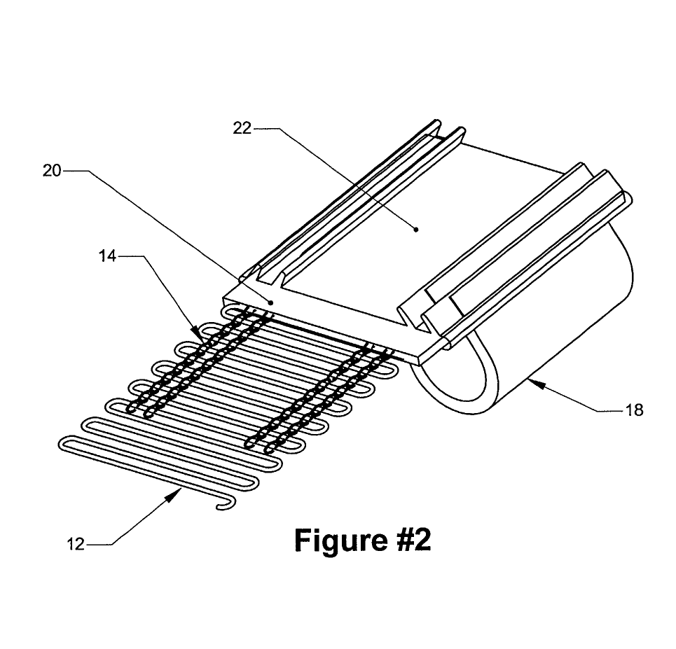

A typical weather seal 10 utilizing a wire carrier 12 and the internal structure thereof is shown in FIG. 1. The figure shows the carrier in a flat condition for convenience of illustration. The actual final product has the carrier formed into a “U” shape. The wire carrier 12 is a continuous succession of loops formed of steel wire. Strands of multifilament polyester yarn 14 are knitted onto the loops and extend longitudinally on the loops. These yarns provide longitudinal reinforcement elements, which limit the longitudinal extendibility of the weather seal 10, without limiting the compressibility and bendability thereof so as to provide the requisite “U” shape. Typically the wire carrier, preformed into loops and with knitted yarn elements attached, is shipped and stored in rolls of several hundred lineal feet. A roll is placed behind an extrusion line. The carrier is dispensed and rolls formed into a “U” shape appropriate for entry to an extrusion die. The carrier is fed into the die and dense virgin or uncured EPDM rubber is extruded and forms an encapsulation 16 on the carrier. A second extruder also feeds the same die and creates a seal shape profile element of foam or low-density EPDM 18 which is extruded on the dense rubber portion. The extruded foam profile element 18 is shown as a bulbous portion which contributes to the sealing action of the weather seal. After extrusion the composite product is cured and cut to length for installation by the automotive manufacturer.

In addition to the patents on various styles of weather seal, including those noted above, carriers of various designs have been proposed. These designs include different schemes for longitudinal extension limitation, such as the use of yam knitted or stitched on the wire carrier loops as noted above. There are a plethora of such patents and known ones thereof are listed below. Bonds, U.S. Pat. No. 6,079,160 of Jun. 27, 2000; Vinay, U.S. Pat. No. 5,416,961 of May 23, 1995; McManus et al., U.S. Pat. No. 5,143,666 of Sep. 1, 1992; Keys, U.S. Pat. No. 5,095,656 of Mar. 17, 1992; Cook et al., U.S. Pat. No. 5,072,567 of Dec. 17, 1991; McManus et al., U.S. Pat. No. 5,009,947 of Apr. 23, 1991; Keys, U.S. Pat. No. 4,970,101 of Nov. 13, 1990; Smith, U.S. Pat. No. 4,830,898 of May 16, 1989; Bright, U.S. Pat. No. 4,699,837 of Oct. 13, 1987; Gibson, U.S. Pat. No. 4,624,093 of Nov. 25, 1986; Weimar, U.S. Pat. No. 4,542,610 of Sep. 24, 1985; Weichman, U.S. Pat. No. 4,517,233 of May 14, 1985; Burden et al., U.S. Pat. No. 4,343,845 of Aug. 10, 1982; Jackson, U.S. Pat. No. 4,188,765 of Feb. 19, 1980; Bright, U.S. Pat. No. 4,099,765 of Jul. 11, 1978; Lansing, U.S. Pat. No. 3,198,689 of Aug. 3, 1965; Tea, U.S. Pat. No. 2,102,392 of Dec. 14, 1937; Lansing, U.S. Pat. No. 3,755,873 of Sep. 4, 1973; LePlae, U.S. Pat. No. 3,222,769 of Dec. 14, 1965; Lynch, U.S. Pat. No. 3,159,886 of Dec. 8, 1964 and Bright, U.S. Pat. No. 4,304,816 of Dec. 8, 1981.

There are disadvantages with the above described weather seal and the carriers thereof. It is a feature of the present invention to substantially eliminate these disadvantages and contribute to the reduction in the cost of the weather seal.

It has been discovered in accordance with the invention that high cost uncured or virgin EPDM rubber (the extruded dense encapsulation 16 of FIG. 1), which is required to fill the voids within the carrier (spaces between the metal loops or stampings in the case of stamp carriers) may be replaced with a substrate layer. For example, an extrusion of a tape or tapes which sandwich the carrier and which substrate is made of much lower cost material. The presently preferred material is cured recycled fine mesh (approximately 100 to 200 mesh) EPDM rubber. This material is approximately 15 percent the cost of uncured or virgin EPDM material. The substrate fills the voids within the carrier and masks ripples or reed marks on the surface of the final weather seal due to the wire loops of the carrier. The substrate is of sufficient thickness to capture the carrier and hold it in place notwithstanding the lack of chemical bonding between the metal of the wire loops and the substrate material. The substrate may be a blend of pure EPDM rubber in a thermoplastic binder. By way of example the substrate material may be 70% by weight regrind, 100 mesh, cured EPDM rubber and 30% olefinic copolymer. This material, upon extrusion into molten or semi-molten tapes for encapsulating the carrier the thermoplastic material, forms a matrix binding the cured rubber.

Advantages flowing from the use of this substrate in addition to reducing the cost of the entire rubber encapsulation, is to maintain loading levels of the encapsulation (called filler loading levels) and allowing such levels to be greater than 50%; to provide a bond compatible to both cured and uncured EPDM rubber; to be non-hydroscopic (for example water absorption less than 0.8%); to be undegradable by the rubber extrusion and curing process and to tolerate temperatures of such process which may be 210C.; to have sufficient strength to maintain integrity of the tape or other extrusion of the substrate during the overcoat extrusion with the dense EPDM and EPDM foam; and to provide flexibility as well as hardness over the temperature range specified for automotive weather seals. In other words, the substrate does not degrade the temperature flexibility and hardness of the weather seal.

The invention also provides a carrier especially of the continuous wire loop type, which avoids the drawbacks of knitted yam reinforcing elements while providing sufficient compressibility and even enhancing control of longitudinal extension (stretching). A principal disadvantage of the use of knitted yam is the amount of yam required which, of course, characterizes the cost of the yam. For every unit length of carrier, knitting requires the yarn to be slightly more than three times as long (one foot of knitted wire carrier contains in each strand of yarn for three feet of knitted yarn). Another disadvantage is that the longitudinal control with knitted yarn elements is not constant. It is believed that such variation in control is a function of knot tightness which can vary for knitted yarn. Thus knitted yarns produce higher than desirable length variation in the weather seal. This is especially the case during encapsulation, which can change the tightness of the knots. Knit yarns may slide laterally and sometimes require an additional process step of an adhesive coating to maintain their lateral location on the wire loops. The knitting process is time consuming and requires complex stitching mechanisms which adversely affect manufacturing costs. Knitting also limits the materials of the reinforcement elements. It is a feature of the invention to enable the use of reinforcement elements in the form of fiberglass strands, metal wire (steel or aluminum) and monofilaments, which are not amenable to knitting.

In order to provide a wire carrier or other core with reinforcement elements which may be attached without knitting, the invention provides a mechanism including a wheel which captures the loops of the carrier and present a surface of the loops for the application of the reinforcement elements, which are wrapped around the wire carrier and the wheel as the wheel carries the loops. At a process station, the reinforcement elements are attached to the exposed face of the loops by processes which depend upon the nature of the elements. For example for yarn elements, including polyester yarns and other materials such as fiberglass yarns, hot melt or other chemical bonding of the yarn to the wire loops may be used. In the case of metallic elements, fusion bonding by laser or spot welding may be carried out at the process station. Monofilaments of plastic with the requisite yieldability for stretch control may be directly extruded onto the wire loops so that the extruded monofilaments meet the wire loops at the process station and are carried around the wheel with the loops. A substrate tape, as described above, may be extruded or otherwise applied at the process station so as to directly embed the control elements or yarns which have been placed on the wire loops.

The reinforcement elements may be of plastic, for example, polyester, fiberglass, metal (steel or aluminum wire), or monofilament material depending upon the specified allowable stretch of the weather seal. Presently polyester yams having multiple strands are preferred.

The foregoing objects features and advantages of the invention will become more apparent from a reading of the following description in connection with the accompanying drawings on our list of which is presented below.

FIG. 1 is a perspective view of a prior art wire carrier weather seal showing its internal structure. The weather seal is shown flat to facilitate illustration of the internal construction.

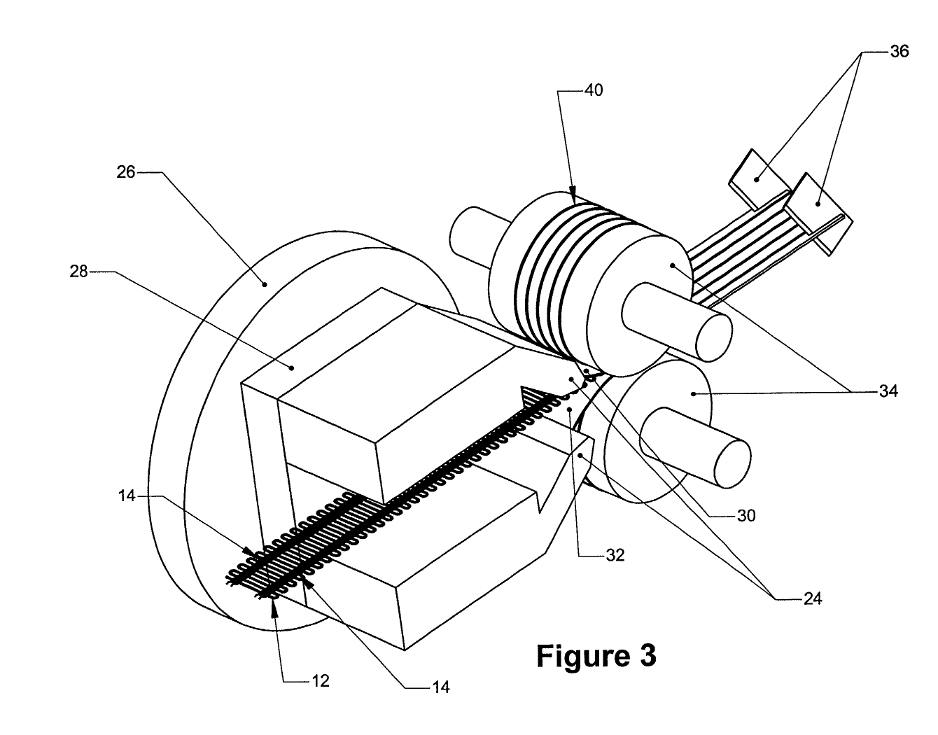

FIG. 2 is a perspective view similar to FIG. 1 showing a wire carrier in an encapsulating filler or substrate as well as the external coating of dense and foam rubber.

FIG. 3 is a perspective view illustrating the tooling for extruding and applying tapes which form the substrate to the wire carrier.

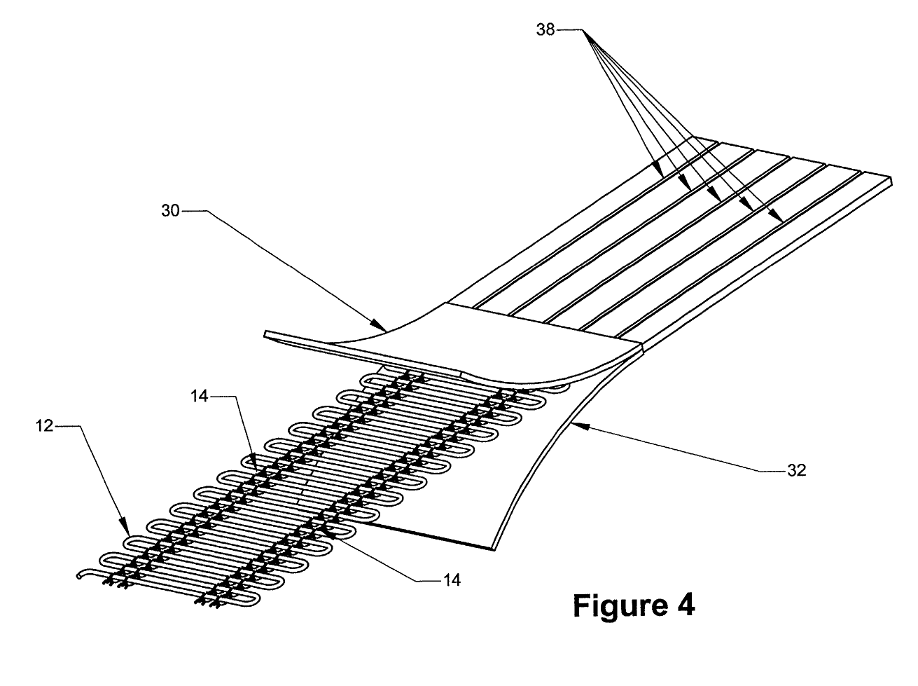

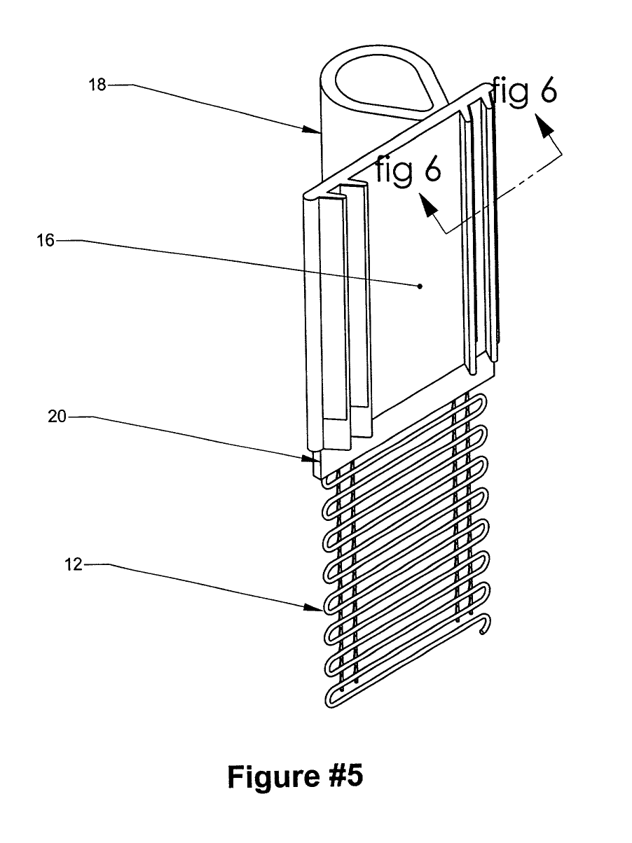

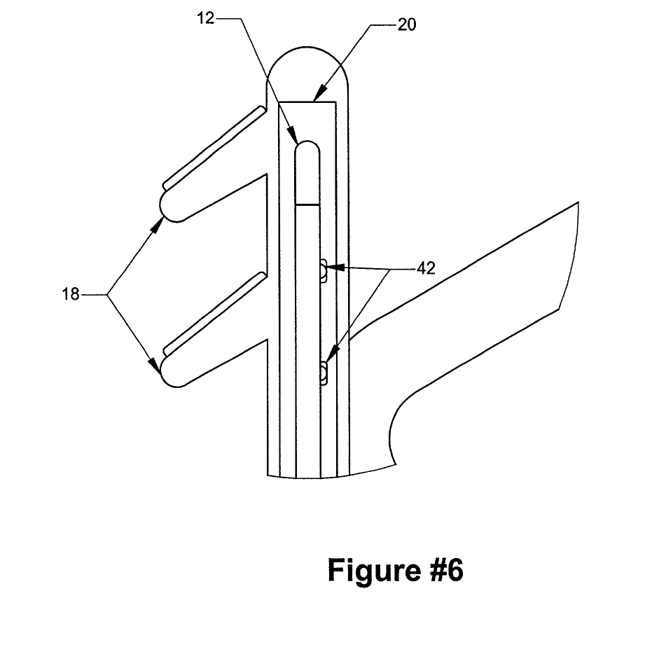

FIG. 4 is a perspective view schematically illustrating the wire carrier sandwiched between tapes which form the substrate of low-cost (recycled) rubber.

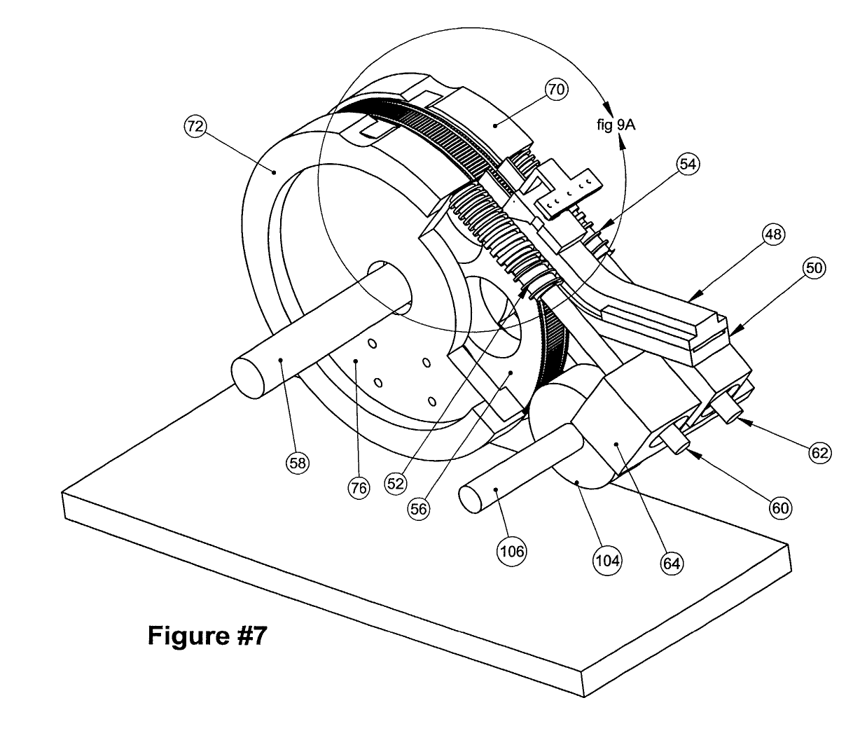

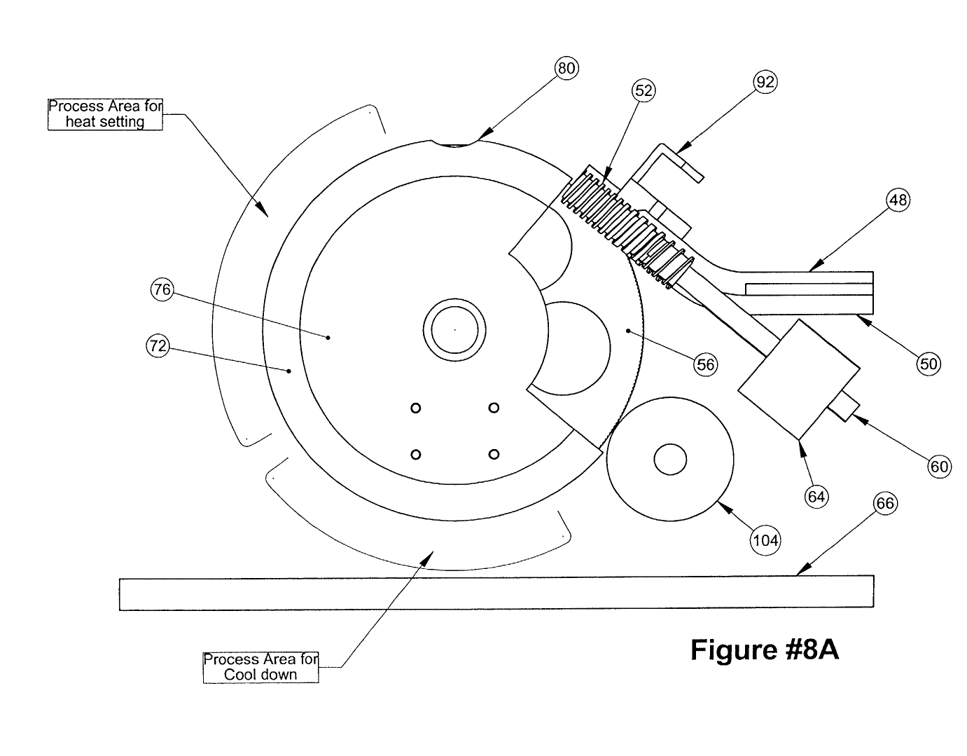

FIG. 5 is a perspective view illustrating a weather seal in flat condition with a substrate and a wire carrier having reinforcement elements laid longitudinally on one side of the loops of the carrier.

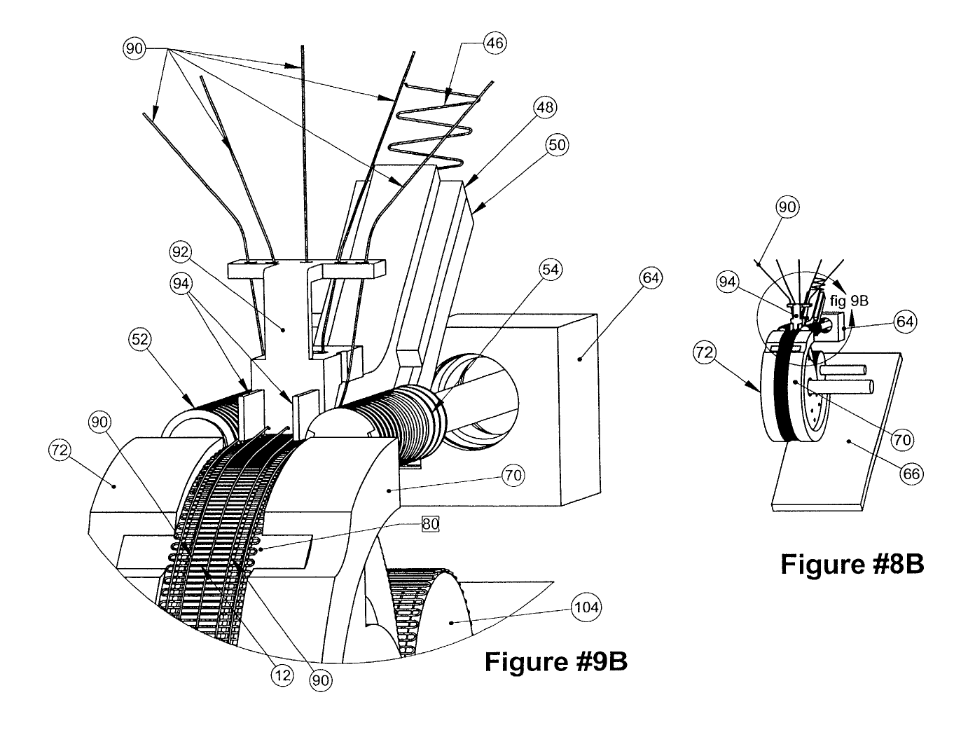

FIG. 6 is a fragmentary sectional view of the weather seal in FIG. 5 taken along the line 6-6 in FIG. 5.

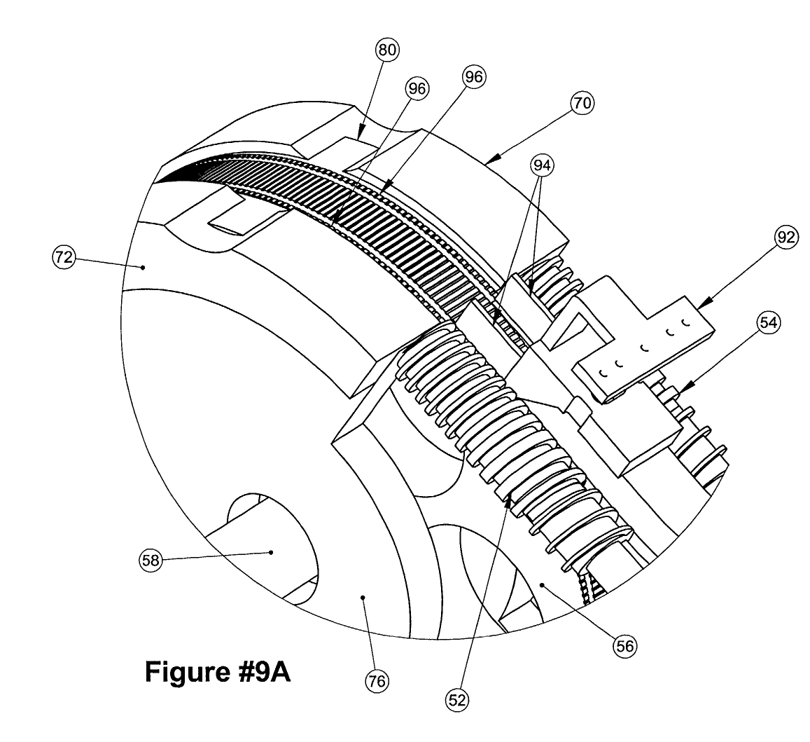

FIG. 7 is a simplified perspective view of the mechanism used to make wire carriers having longitudinal extension control elements along one side of the loops.

FIGS. 8A and 8B are side views of the mechanism shown in FIG. 7 and front perspective views of this mechanism.

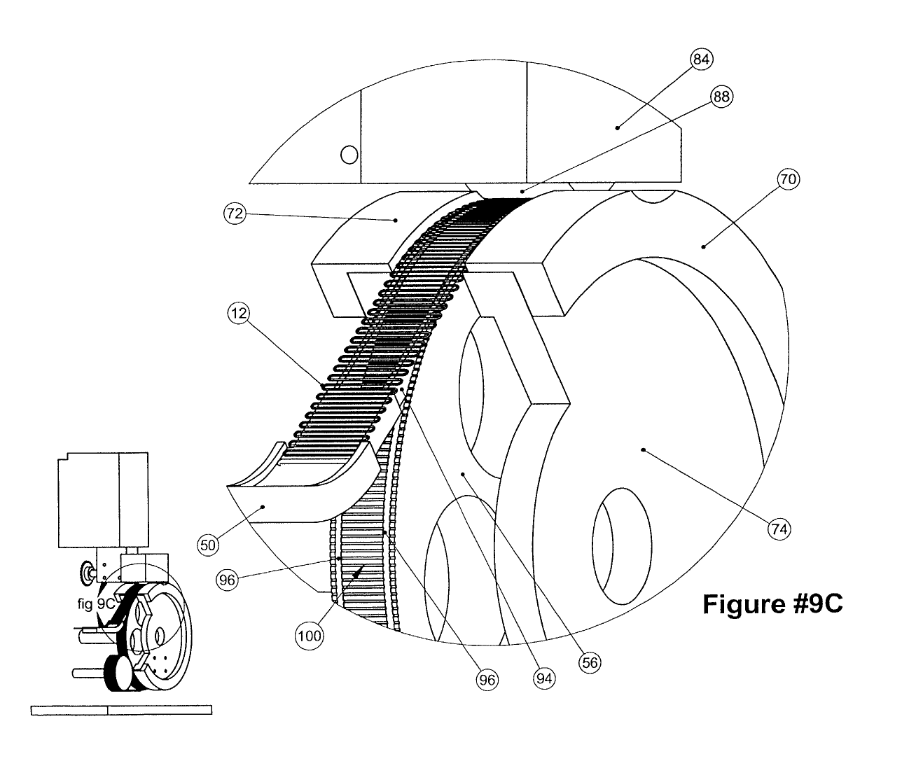

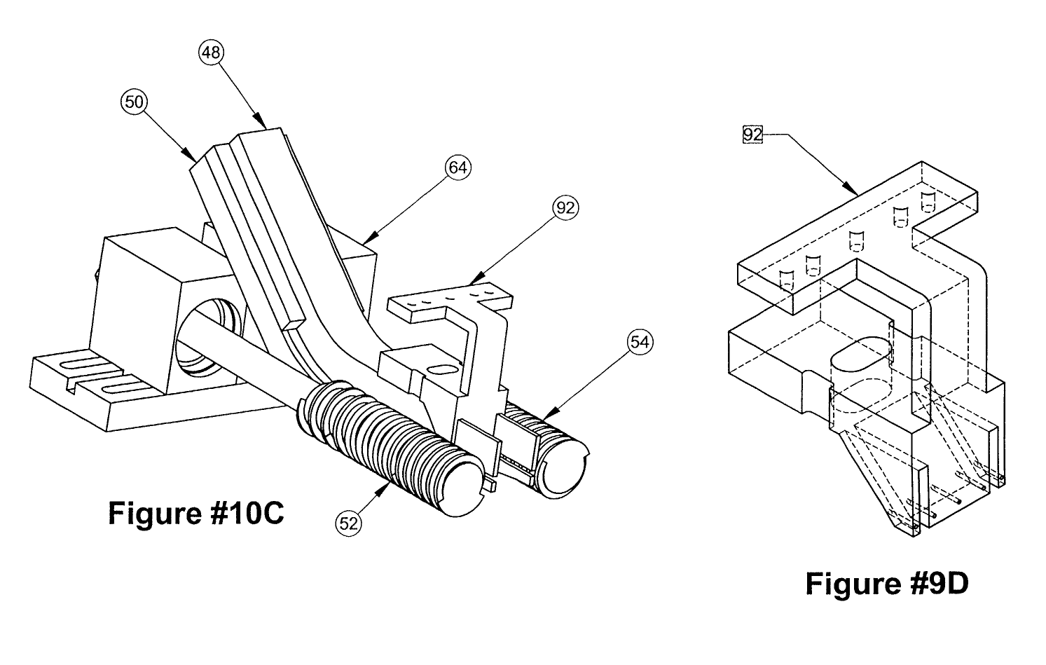

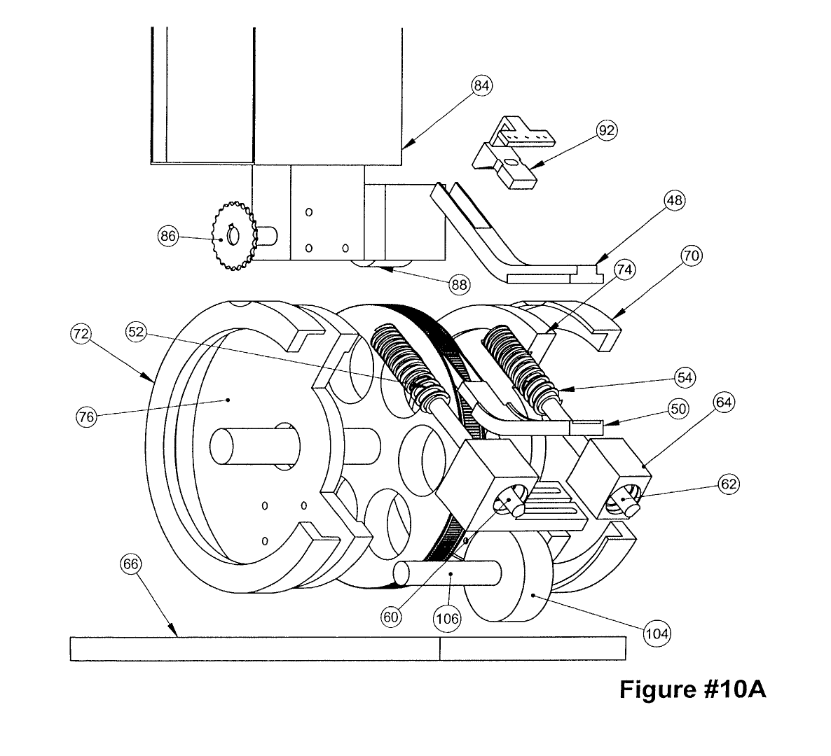

FIGS. 9A, 9B, 9C and 9D are respectively enlarged perspective views, FIG. 9A being of the area indicated within the circle 9A in FIG. 7 from the side and the front, FIG. 9C showing the guidance of the wire loops onto the wheel downstream of the process station where the reinforcement elements are attached to the outside of the wire loops, and FIG. 9D being a perspective view of the yarn in the guide through which five strands of yarn are drawn onto the outside of the wire loops as shown in FIG. 9B.

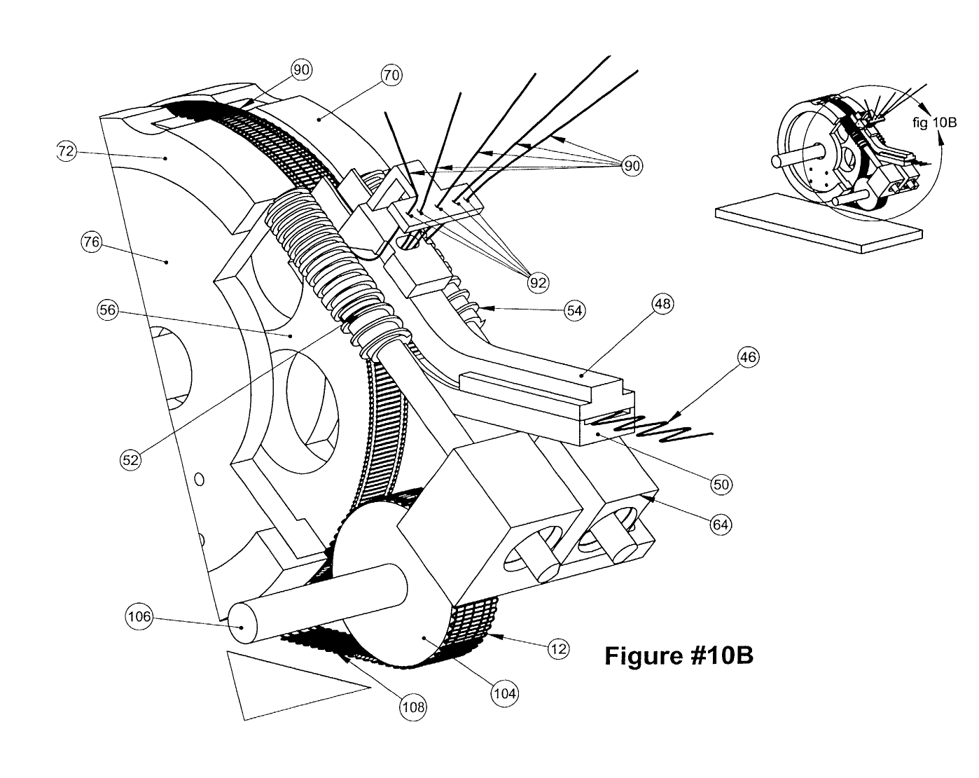

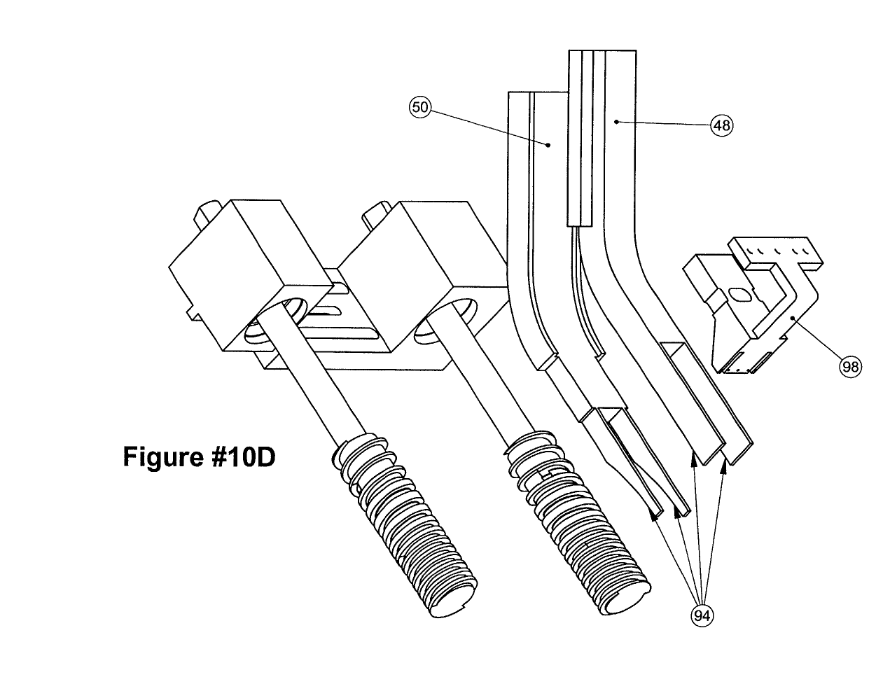

FIGS. 10A, 10B, 10C and 10D are perspective views showing the mechanism in greater detail. The view being exploded in FIG. 10A; being enlarged and showing the product discharge area in FIG. 10B; enlarged and showing the feed screws and guides for the wire carrier in FIG. 10C; and showing the feed screws and guides parts which are assembled in FIGS. 10B and 10C, exploded in FIG. 10D.

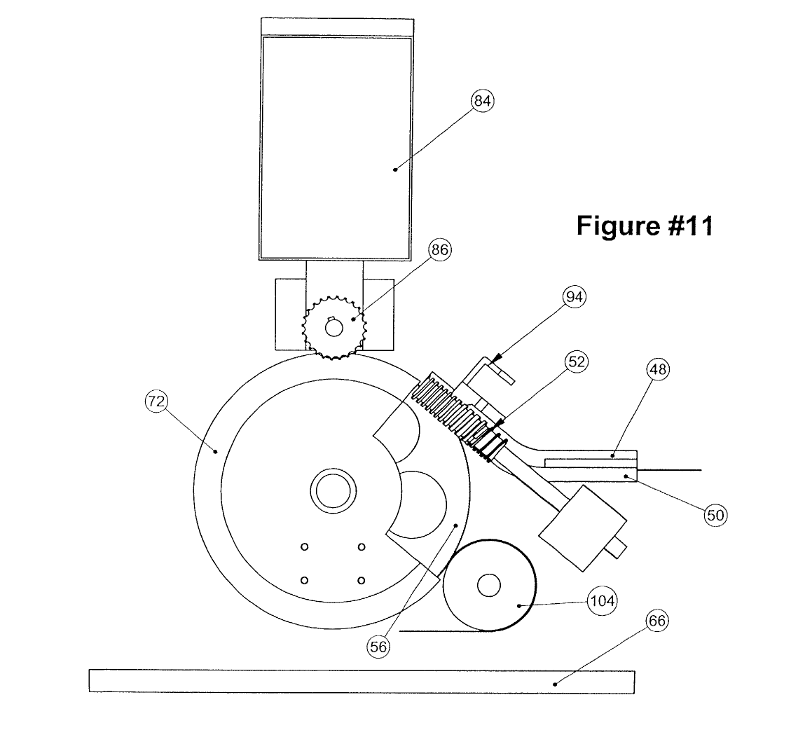

FIG. 11 is a side view of the mechanism similar to FIG. 8A, but with a hot melt applicator unit at the process station where the reinforcement elements are attached to the wire loops.

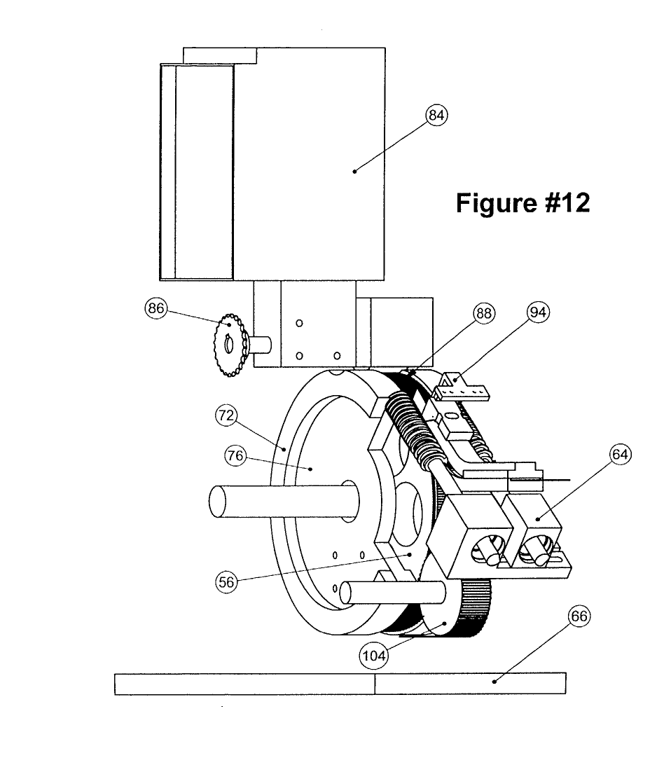

FIG. 12 is a perspective view of the mechanism similar to what is shown in FIG. 7 but including the hot melt adhesive applicator unit.

Referring more particularly to FIG. 2 there is shown a wire carrier 12 having four lengths of multifilament polyester yarn reinforcement elements 14 knitted on the loops of the carrier. Over the loops of the carrier 12 is a substrate or encapsulating filler 20 of recycled cured EPDM rubber. This filler may be also of other thermoplastic material such as thermoplastic rubber (TPR) which is also of low cost. The substrate completely encapsulates the carrier with the knitted yarn reinforcement elements and is sufficiently thick to hold these elements during further extrusion processes as well as to completely fill the voids between the wire loops. The thickness is also sufficient to reduce ripples or reed marks (hungry horse effect). The substrate is encapsulated by a layer of extruded dense EPDM rubber 22 of the type discussed above in connection with tape 1. The material content of this virgin rubber in the weather seal is reduced by approximately 50% that for the style of weather seals shown in FIGS. 1 and 2 over weather seals which are entirely filled with dense virgin rubber (as illustrated in FIG. 1). Extruded foam profile elements 18, similar to those shown in FIG. 1, complete the weather seal.

Referring to FIGS. 3 and 4 there is shown the wire carrier 12 with reinforcing elements 14 thereon being advanced through extrude tape dies 24 attached to an extruder head block 26 via an extruder flow splitter 28, which splits the flow of the substrate material which is molten to the dies 24. The dies extrude molten tapes 30 and 32. The tapes 30 and 32 and the carrier 12 with its reinforcement elements 14 are fed into a set of cooled hip rolls 34. These rolls in 34 define the thickness of the substrate. The wire carrier 12 and its reinforcement elements 14 are preheated, for example to approximately 150 C. prior to the rolls 34. The substrate-coated carrier is pulled through the rolls. Conventional extrusion caterpillar pull belts (not shown) may be used. Excess extradite may be trimmed from the edges of the resulting tape by scissors 36. The product once cooled is wound onto cores to provide rolls which may be sold as an intermediate product. This product is then fed to further extruders which provide the dense virgin rubber coating 22 and the foam bulb and rib profile 18.

Alternatively the carrier 12 and its reinforcement 14 may be sandwiched between two molten or semi-molten tapes. A single tape may be used and compressed into a carrier in order to fill the voids between the loops and between the reinforcement elements 14. The rolls 30 are shown as ridged to ensure that the carrier 12 sits central to the tapes 30 and 32 as they are extruded.

FIG. 4 shows the product in various stages of processing and how the tapes 30 and 32 sandwich the carrier 12 and its reinforcement elements 14. The final product has depressions 38 caused by the centering ribs 40 of the cooling rolls 34.

FIGS. 5 and 6 show the formed wire loops of the carrier and reinforcement elements 42 laid down on one side of the loops of the carrier 12.

The apparatus for applying these reinforcement elements is illustrated in the remaining figures of the drawings.

The carrier is initially in the form of sinus, preformed wire loops 46 (FIG. 10B). These elements are fed via upper and lower guides. Worm-like feed screws 52 and 54 engage the ends of the preformed loops 46 and compress them. These screws also feed the loops onto a loop wheel 56 which is rotated by a shaft 58. The screws are rotated by shafts 60 and 62 which are supported in a bearing block 64. The block 64 is fixedly held on the base 66 of the apparatus. Ribs and struts which support the bearing block 64 and other struts and supports which support other stationary elements of the machine are not shown to simplify the illustration. The rotation of the screws 52 and 54 are synchronized with the rotation of the wheel 56, as by driving them from a common motor through a gear train.

Stationary side guides 70 and 72 are attached to the stationary side disks 74 and 76. A sector in the disks allows room for the feed screws 52 and 54 and guides 48 and 50, which guide the carrier 12. An area defined by an indentation 80 is a process area for attachment on application of the yarn reinforcement elements by gluing with hot melt or two component glues, or by fusion with sonic laser or heat embedding into a substrate tape extrusion of monofilaments. The gluing is to the yarn strands of the reinforcement elements where they cross the loops. The drawings, particularly FIGS. 9C, 10A, 11 and 12 show a hot melt applicator 84, which may be a commercial device such as the “spotwheel” applicator which is sold by Graco LTI. In this applicator a sprocket 86 which is driven synchronously with the wheel 56 and feed screws 52 and 54 and drives a printwheel rotating in a tank. The hot melted adhesive is applied at the crossovers of the element (yarn strands and wire loops) via a printwheel 88 which contacts the strands of reinforcement elements after they have been brought and laid upon the loops of the carrier 12, as shown best in FIG. 9B.

FIG. 9B illustrates the use of five strands of yarn 90 which are led via eyelet in a guide 92 which is mounted by slots therein on legs 94 extending from the upper guide 48. These legs fit into grooves 96 in the periphery of the wheel 56.

The periphery of the wheel may have lateral notches 100 which cross the grooves 96, as is best shown in FIG. 9C. The wire loops of the carrier 12 fall into these notches which capture the loops during the lay down of the reinforcement elements. The reinforcement elements are wrapped around the wheel 56. These elements are under tension due to back tension on the reels which feed the yarn 90 and the pinching action of a pickup wheel 104. This wheel may be driven via a shaft 106 synchronously with the wheel 56. The final product, namely the reinforced carrier is discharged at 108 below the wheel 56 and the pickup wheel 104.

After application of the adhesive, additional dwell of the yarns against the wire loops is maintained for approximately 220 C. around the wheel 56 (see FIG. 8A). This area may be used in the case of hot melt bonding to allow heating of the adhesive causing it to flow and attach itself more fully to both the yarn 90 and the wire of the carrier 12. The product may then be cooled to allow the adhesive to harden. Once the product has a bonded into one piece assembly, it is removed from the loop wheel 56 at the pickup wheel 104. In cases where the carrier is not produced directly with the embedding of the substrate and the sealing layers of EPDM, the carrier may immediately be wound on rolls for transport to a customer. Alternatively the product may be directed to a secondary encapsulating processes for completing either the substrate coating, or the substrate coating and the extrusion of sealing profile elements, as discussed above.

Although hot melt bonding in the process area is presently preferred, other attachment of the reinforcement elements to the wire loops may be used. For example a two component rapid cured adhesive may be applied via nozzles at the process area 80. Laser welding may be used in the case of metal reinforcement elements. Sonics or heat may be used in the case of thermal plastic adhesives. For example a thermoplastic adhesive coating may be preapplied to yarn reinforcement elements 90 so as to facilitate sonic heating for adhesion of the yarns to the loops of the wire carrier. Alternatively the yarn and the carrier may be embedded in a substrate, such as the EPDM or TPR tapes so as to provide sufficient mechanical attachment to the wire loops. The tape may be fed onto the exposed side of the assembly in the process area and compressed to the required thickness by rolls which engage the tape and press it against the wire loops and reinforcement elements.

Where yarn is used, it may suitably be 1000/192 denier polyester yarn. Steel wire reinforcement elements may be C1010 steel wire of 0.030 inch diameter. The steel wire may be 316 stainless steel also 0.030 inch diameter. Aluminum wire may be used, such as 5056 aluminum wire of 0.032 inch diameter.

From the foregoing description it will be apparent that there has been provided improved weather seals of the type having internal cores or carriers overcoated with elastomeric sealing material, and processes of fabricating same. Variations and modifications in the herein disclosed weather seal and apparatus will, undoubtedly, become apparent to those skilled in the art. For example, one can apply a tape at the application area (80), which acts as a binder; securing itself to both the yarn and the wire loops. As a result, the yarn and wire loops can be secured to each other indirectly, by way of the tape. When the assembly is removed from the wheel (104), a second tape is applied to complete the attachment and encapsulation. Physical characteristics of the tape may be the same as the substrate, with the additional characteristic of providing a temporary bond to both the wire loops and the yarn (reinforcement elements) prior to the application of the opposing tape. Accordingly the foregoing description should be taken as an illustrative and not in a limiting sense.

1. A weather seal comprising a core, a substrate of recycled elastomeric material encapsulating said core, a covering of virgin elastomeric material providing a sealing surface and encapsulating said core and substrate.

2. The weather seal according to claim 1 where the core is a wire loop carrier.

3. The weather seal according to claim 1 wherein the recycled material is cured EPDM or TPR which is applied in molten or semi-molten form as a tape or tapes.

4. The weather seal according to claim 3 wherein the material is extruded to form said tape or tapes.

5. A weather seal comprising a core, longitudinal extension control and reinforcing elements applied along one side by carrying said core around a wheel which exposes a space thereof, applying said element through said space as said wheel rotates, and attaching said elements to said space after application.

6. The weather seal according to claim 5 wherein said elements are yams including polyester or fiberglass strands, or metal wires or monofilaments.

7. The weather seal according to claim 6 wherein said attaching step is carried out by chemical bonding, as with adhesive applied where said elements contact the core, or by fusion bonding or by encapsulation of said elements with said core.

8. The weather seal of claim 3, further comprising one or more reinforcement elements adjacent to and along the length of said core, said tape encapsulating said core and attaching said reinforcement elements to said core.
